(19) United States
(12) Patent Application Publication
(10) Pub. No.: US 2008/0102253 A1
(43) Pub. Date: May 1, 2008

(54) Patterned thin-film layer and method for manufacturing same

(75) Inventors: Ching-Yu Chou, Hsinchu (TW); Wen-Tsing Chen, Cupertino, CA (US)

Correspondence Address: PCE INDUSTRY, INC.;ATT. CHENG-JU CHIANG J, 458 E. LAMBERT ROAD, FULLERTON, CA, 92835, US

(73) Assignee: ICF Technology Limited., Santa Clara, CA (US)

(21) Appl. No.: 11/309,934

(22) Filed: Oct. 31, 2006

(51) Int. Cl. G03G 7/00

(52) U.S. Cl. 428/195.1

(57) ABSTRACT

A patterned thin-film layer (100) includes a substrate (102), a plurality of banks (104) formed on the substrate and a plurality of thin-film layers (106). The plurality of banks define a plurality of spaces therein, and the spaces are arranged in rows and columns. The plurality of patterned thin-film layers formed in the plurality of spaces in a manner such that the patterned thin-film layers made of a same material in each row have an irregular thickness distribution. A method for manufacturing a patterned thin-film layer is also provided.

### 1. TECHNICAL FIELD

The present invention generally relates to a patterned thin-film layer and a method for manufacturing the same on a substrate.

### 2. DISCUSSION OF RELATED ART

At present, methods for manufacturing a patterned thin-film layer on a substrate include a photolithographic method and an ink-jet method.

The photolithographic method is described as below: applying a photoresist layer on a substrate; exposing the photoresist layer using a photo mask with a predetermined pattern and developing the exposed photoresist layer to form a predetermined patterned thin-film layer. Thus a large part of the photoresist material is wasted and the efficiency is low. This increases the cost.

The ink-jet method uses an ink-jet device with a number of nozzles for depositing ink into a predetermined position on a substrate structure. A patterned thin-film layer is formed after solidifying the ink. Generally, for an area of the substrate structure is larger than a covering area of the nozzles, the nozzles of the ink-jet device move relatively in a matrix manner with the substrate structure to finish depositing the ink on the substrate structure.

In a conventional patterned thin-film layer formed by the ink-jet method, thin-film layers made of same material in each row are deposited by a same nozzle, and thicknesses of the such thin-film layers are same. Therefore, uniformity of the thin-film layers made of same material in each row is high. However, the thin-film layers made of same material in different row are deposited by different nozzles such that thicknesses of the such thin-film layers are different. Therefore, non-uniformities of the thin-film layers between different rows are easily identified by a test operator when light passes therethrough, and linear Mura defects are formed.

What is needed, therefore, is a patterned thin-film layers with less or no Mura defects and a method for manufacturing the same.

### SUMMARY OF THE INVENTION

A patterned thin-film layer according to one preferred embodiment includes a substrate, a plurality of banks formed on the substrate, and a plurality of patterned thin-film layers. The plurality of banks define a plurality of spaces therein, and the plurality of spaces are arranged in rows and columns. The plurality of patterned thin-film layers formed in the plurality of spaces in a manner such that the patterned thin-film layers made of a same material in each row have an irregular thickness distribution.

A method for manufacturing a patterned thin-film layer according to another preferred embodiment includes the steps of: providing a substrate with a plurality of banks thereon, the plurality of banks defining a plurality of spaces therein, the plurality of spaces arranged in rows and columns; depositing ink into the spaces in a manner such that the ink of a same material deposited in the spaces in each row have an irregular volume distribution; and solidifying the ink so as to form a plurality of patterned thin-film layers formed in the spaces in a manner such that the patterned thin-film layers made of the same material in each row have an irregular thickness distribution.

A method for manufacturing a patterned thin-film layer according to another preferred embodiment includes the steps of: providing a substrate with a plurality of banks thereon, the plurality of banks defining a plurality of spaces therein; depositing ink into the spaces using a plurality of nozzles of at least one ink-jet device and having the relative movement in rows and columns between the plurality of nozzles and the substrate so that the ink of a same material deposited in the spaces in each row have an irregular volume distribution; and solidifying the ink so as to form a plurality of patterned thin-film layers formed in the spaces in a manner such that the patterned thin-film layers made of the same material in each row have an irregular thickness distribution.

Advantages and novel features will become more apparent from the following detailed description of the present patterned thin-film layer and its related method, when taken in conjunction with the accompanying drawings.

### BRIEF DESCRIPTION OF THE DRAWINGS

Many aspects of the present patterned thin-film layer and its related manufacturing method can be better understood with reference to the following drawings. The components in the drawings are not necessarily drawn to scale, the emphasis instead being placed upon clearly illustrating the principles of the present patterned thin-film layer and its related manufacturing method. Moreover, in the drawings, like reference numerals designate corresponding parts throughout the several views.

FIG. 1 is a cross-sectional view of a patterned thin-film layer in accordance with a first preferred embodiment;

FIG. 2 is another cross-sectional view of a patterned thin-film layer, showing a thickness distribution of thin-film layers in one row;

FIG. 3 is a cross-sectional view of a patterned thin-film layer in accordance with a second preferred embodiment;

FIG. 4 is a flow chart of a method for manufacturing a patterned thin-film layer in accordance with a third preferred embodiment;

FIGS. 5a to 5f illustrate a manufacturing method of a patterned thin-film layer in accordance with the third preferred embodiment;

FIG. 6 is a cross-sectional view of a substrate in accordance with a third preferred embodiment; and

FIG. 7 is a flow chart of a method for manufacturing a patterned thin-film layer in accordance with a fourth preferred embodiment.

Corresponding reference characters indicate corresponding parts throughout the drawings. The exemplifications set out herein illustrate at least one preferred embodiment of the present patterned thin-film layer and its related method, in one form, and such exemplifications are not to be construed as limiting the scope of the invention in any manner.

### DETAILED DESCRIPTION OF THE INVENTION

Reference will now be made to the drawings to describe preferred embodiments of the present patterned thin-film layer and its related manufacturing method, in detail.

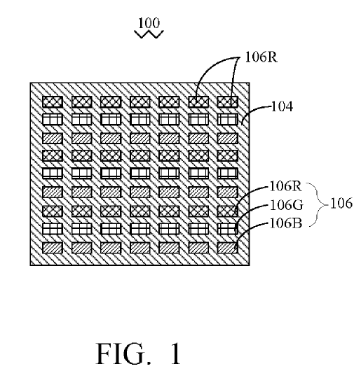

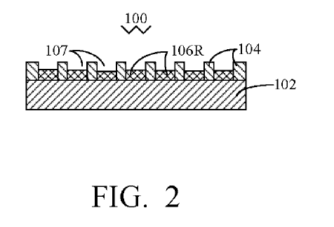

Referring to FIGS. 1 to 2, a patterned thin-film layer 100 in accordance with a first preferred embodiment is shown. The patterned thin-film layer 100 includes a substrate 102, a plurality of banks 104 formed on the substrate 102 and a plurality of thin-film layers 106.

A material of the substrate is selected from the group consisting of glass, quartz glass, silicon wafer, metal and plastic. The plurality of banks 104 define a plurality of spaces therein, and the spaces are arranged in rows and columns on the patterned thin-film layer.

Referring to FIGS. 1 to 2 again, the plurality of thin-film layers 106 include a plurality of first thin-film layers 106R, second thin-film layers 106G, and third thin-film layers 106B. The plurality of first thin-film layers 106R, second thin-film layers 106G, and third thin-film layers 106B are formed in the spaces in a manner such that thin-film layers 106 in each row are made of a same material but an irregular thickness distribution, and the thin-film layers 106 in every three rows include the first thin-film layers 106R, the second thin-film layers 106G and the third thin-film layers 106B arranged in a regular repeating order. That is to say, for example, the thicknesses of adjacent thin-film layers 106R, which are in the same row, may differ. A uniformity of the thin-film layers 106R array in each row is reduced due to an irregular thickness distribution of the thin-film layers 106R. Therefore, a non-uniformity of the thin-film layers 106R array in each row is formed, and linear Mura defects are reduced or avoided when light passes therethrough. The second thin-film layers 106G and the third thin-film layers 106B encounter a similar situation.

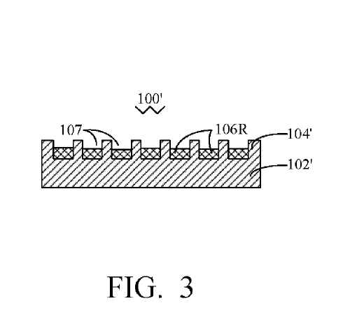

Referring to FIG. 3, a patterned thin-film layer 100′ according to a second preferred embodiment is shown. The patterned thin-film layer 100′ of the embodiment is the similar with the patterned thin-film layer 100 of the first embodiment, but the substrate 102′ of the patterned thin-film layer 100′ is integrated with the plurality of banks 104′.

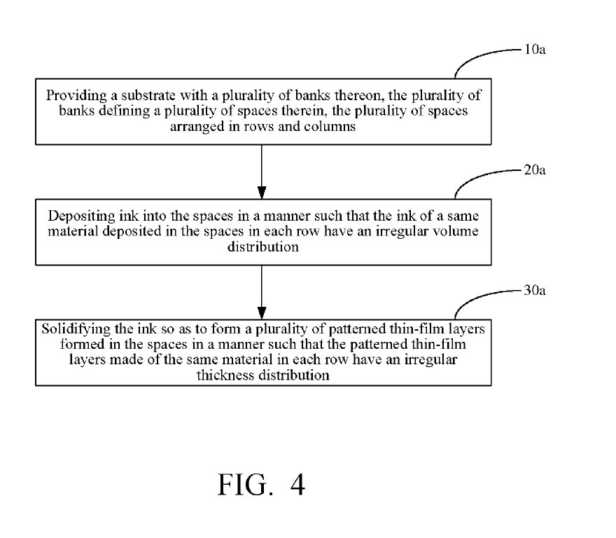

Referring to FIG. 4, a flow chart of a method for manufacturing a patterned thin-film layer in accordance with a third preferred embodiment is shown. The method mainly includes the steps of: (10a) providing a substrate with a plurality of banks thereon, the plurality of banks defining a plurality of spaces therein, the plurality of spaces arranged in rows and columns; (20a) depositing ink into the spaces in a manner such that the ink of a same material deposited in the spaces in each row have an irregular volume distribution; (30a) solidifying the ink so as to form a plurality of patterned thin-film layers formed in the spaces in a manner such that the patterned thin-film layers made of the same material in each row have an irregular thickness distribution.

In step (10a), a material of the substrate is selected from the group consisting of glass, quartz glass, silicon wafer, metal and plastic. In the preferred embodiment, the substrate is a glass substrate.

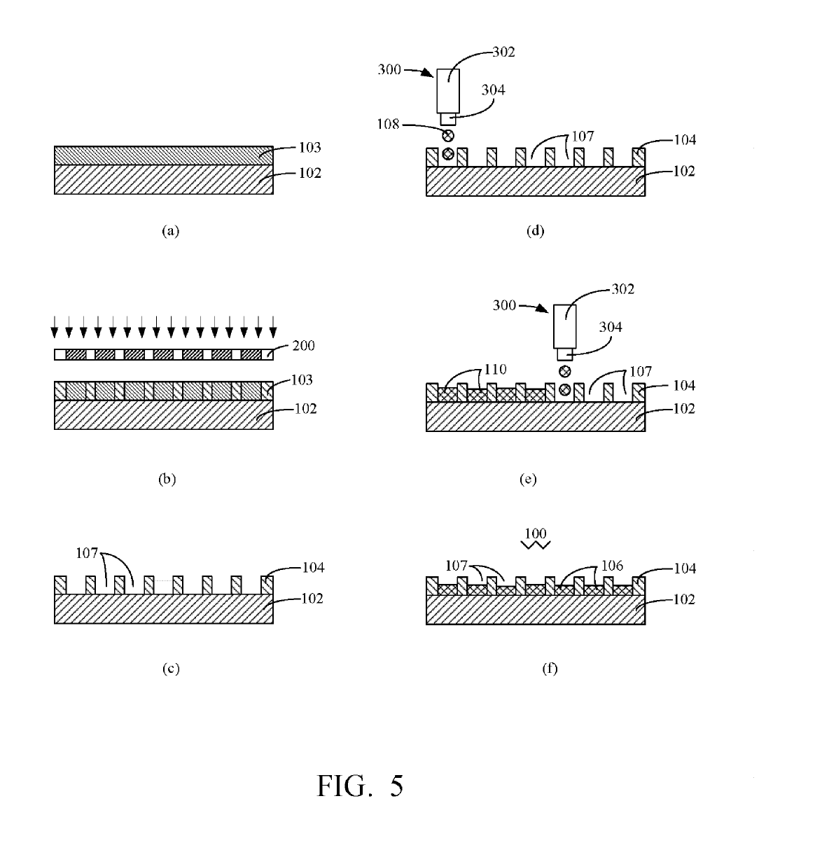

With reference to FIGS. 5(a) to 5(c), a method for manufacturing the substrate 102 with the plurality of banks 104 by a photolithography process is described in more detail below.

Referring to FIG. 5(a), a negative-type photoresist layer 103 is applied on a surface of the substrate 102 by slit coating, spin coating, slit-spin coating or dry film lamination.

Referring to FIG. 5(b), the negative-type photoresist layer 103 is exposed using a photo mask 200 disposed between the negative-type photoresist layer 103 and a light-exposure device 202. The light-exposure device 202 may be an ultraviolet light source. The photo mask 200 has a predetermined pattern for the patterned thin-film layer.

Referring to FIG. 5(c), the unexposed parts of the negative-type photoresist layer 103 is removed by a developing process to form a patterned photoresist layer serving as the plurality of banks 104.

Besides, alternatively, the photoresist layer can be a positive-type photoresist layer. Correspondingly, exposed parts of the positive-type photoresist layer are removed after being developed.

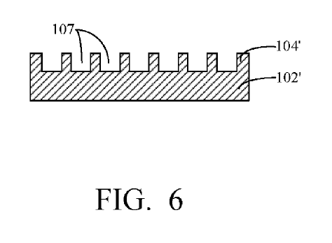

In addition, the plurality of banks 104 and the substrate 102 may also be integrally molded using an injection molding process, as shown in FIG. 6. For example, a mold insert with a predetermined pattern of the banks is received into a mold. A molten material of the substrate is injected in the mold. After being cooled, the molded substrate is removed and provided with the plurality of banks.

Referring to FIGS. 5(d) to 5(e), in step (20a), ink 108 of a desired material is deposited into the spaces 107 to form ink layers 110 using an ink-jet device 300 but the ink has an irregular volume distribution. This is done by controlling an irregular-changed voltage applied to a nozzle 304 of an ink-jet head 302 of the ink-jet device 300. The irregular-charged voltage is a variable-magnitude or a variable-waveform voltage. By the variable-magnitude voltage applied to the nozzle 304 in an irregular fashion, the volume of deposited ink 110 also changes irregularly. The variable-magnitude voltage can be in a range from 80% to 120%, and should preferably be about 90% to 110%, of a reference standard-magnitude of voltage. The reference standard-magnitude of voltage is a voltage that is used in a conventional method for manufacturing a patterned thin-film layer, and is generally constant. For a variable-magnitude voltage applied to the nozzle 304, the volume distribution of the ink 110 having a same material deposited in each space 107 in each row is irregular. The ink-jet device 300 can be either a thermal bubble ink-jet device or a piezoelectrical ink-jet device. The irregular-changed voltage is a variable-magnitude voltage or a variable-waveform voltage.

At depositing time, a relative movement between the nozzle 304 and the substrate 102 is performed so as to finish depositing the ink 108 in the plurality of spaces 107.

Referring to FIGS. 5(d) to 5(e) again, ink 108 is selected from the group consisting of a first thin-film material, a second thin-film material and a third thin-film material, and the ink 108 deposited into the spaces 107 in every three rows includes ink of the first thin-film material, ink of the second thin-film material, and ink of the third thin-film material arranged in a regular repeating order.

Besides the way mentioned above, another way to perform the irregular volume distribution is to deposit variable-number of ink droplets in each row. By the variable-number of ink droplets deposited into the spaces in an irregular fashion, the total volume of deposited ink 110 also changes irregularly. The variable-number of ink droplets can be in a range from 80% to 120%, and should preferably be about 90% to 110%, of a reference standard-number of ink droplet. The reference standard-number of ink droplet is a magnitude that is used in a conventional method for manufacturing a patterned thin-film layer, and is generally constant. For a variable-number of ink droplets, the volume distribution of the ink 110 of a same material deposited in each space 107 in each row is irregular.

Referring to FIG. 5(f), in step (30a), the ink layers 110 in the spaces 107 are solidified by a solidifying device (not shown), such as a heating device or an ultraviolet light source, so as to form a plurality of thin-film layers 106 in the spaces 107 in a manner such that the thin-film layers 106 in each row are made of a same material but an irregular thickness distribution, and the thin-film layers 106 in every three rows comprise the first thin-film layers 106R, the second thin-film layers 106G and the third thin-film layers 106B arranged in a regular repeating order. A heating device and a vacuum-pumping device can also be used for solidifying the ink layers 110 in the spaces 107 defined by the banks 104. Due to the irregular volume distribution of the ink layers 110 of a same material deposited in the spaces 107 in each row, a thickness distribution of the formed same thin-film layers 106 made of a same material in each row is irregular after solidifying the ink layers 110. Therefore, a non-uniformity of the thin-film layers 106 array made of a same material in each row is formed, and linear Mura defects are reduced or avoided when light passes therethrough. A patterned thin-film layer 100 is formed as shown in FIG. 2.

In addition, the banks 104 themselves formed by the photolithography process can also be removed using a remover such as a stripper after solidifying the ink to form a patterned thin-film layer.

The volume distribution of the ink layers 110 of a same material deposited in the spaces 107 in each row is irregular thereby forming an irregular thickness distribution of the thin-film layers 106 made of a same material in each row. Therefore, a non-uniformity of the thin-film layers 106 array made of a same material in each row is formed, and linear Mura defects are reduced or avoided.

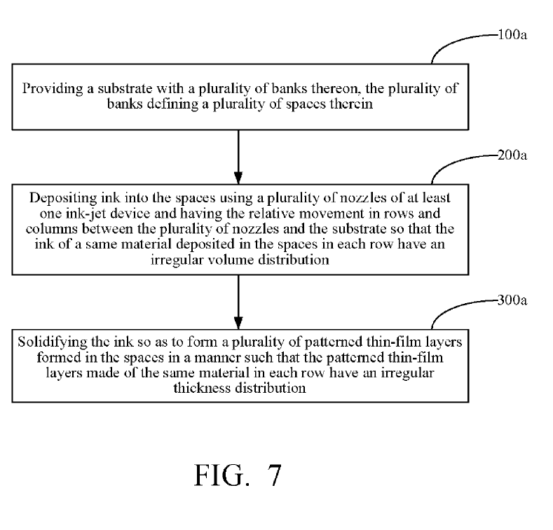

Referring to FIG. 7, a flow chart of a method for manufacturing a color filter in accordance with a fourth preferred embodiment is shown. The method mainly includes the steps of: (100a) providing a substrate with a plurality of banks thereon, the plurality of banks defining a plurality of spaces therein; (200a) depositing ink into the spaces using a plurality of nozzles of at least one ink-jet device and having the relative movement in rows and columns between the plurality of nozzles and the substrate so that the ink of a same material deposited in the spaces in each row have an irregular volume distribution; and (300a) solidifying the ink so as to form a plurality of patterned thin-film layers formed in the spaces in a manner such that the patterned thin-film layers made of the same material in each row have an irregular thickness distribution.

The difference between this embodiment with previous ones is that this embodiment provides a relative movement in rows and columns so that the spaces in the substrate are not necessary to be arranged in rows and columns. More other detail steps of the method of the preferred embodiment are similar with those of the method of the previously presented preferred embodiment. Those skilled in the technical field can refer to the method for manufacturing a color filter or an organic LED according to the previously presented preferred embodiment.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A patterned thin-film layer comprising:
a substrate;
a plurality of banks formed on the substrate, the plurality of banks defining a plurality of spaces therein, the plurality of spaces arranged in rows and columns; and
a plurality of patterned thin-film layers formed in the plurality of spaces in a manner such that the patterned thin-film layers made of a same material in each row have an irregular thickness distribution.

2. The patterned thin-film layer as claimed in claim 1, wherein a material of the substrate is selected from the group consisting of glass, quartz glass, silicon wafer, metal and plastic.

3. The patterned thin-film layer as claimed in claim 1, wherein the plurality of patterned thin-film layers comprises a first thin-film layer, a second thin-film layer, and a third thin-film layer, and the first thin-film layer, the second thin-film layer, and the third thin-film layer are formed in every three rows spaces in that order.

4. The patterned thin-film layer as claimed in claim 1, wherein the substrate is integrated with the plurality of banks.

5. A method for manufacturing a patterned thin-film layer, comprising the steps of:
providing a substrate with a plurality of banks thereon, the plurality of banks defining a plurality of spaces therein, the plurality of spaces arranged in rows and columns;
depositing ink into the spaces in a manner such that the ink of a same material deposited in the spaces in each row have an irregular volume distribution; and
solidifying the ink so as to form a plurality of patterned thin-film layers formed in the spaces in a manner such that the patterned thin-film layers made of the same material in each row have an irregular thickness distribution.

6. The method as claimed in claim 5, wherein a method for manufacturing the plurality of banks comprising the steps of:
applying a photoresist layer on the substrate;
exposing the photoresist layer; and
developing the photoresist layer to form a patterned photoresist layer serving as the plurality of banks.

7. The method as claimed in claim 5, wherein a method for manufacturing the plurality of banks comprising the steps of:
providing a injection mold machine, and a mold with a predetermined bank pattern;
injecting a material of the substrate into the mold using the injection mold machine;
demoulding the mold to form the substrate with the plurality of banks.

8. The method as claimed in claim 5, wherein a material of the substrate is selected from the group consisting of glass, quartz glass, silicon wafer, metal and plastic.

9. The method as claimed in claim 5, wherein the ink deposited in the spaces comprises a first thin-film material, a second thin-film material, and a third thin-film material, and the first thin-film material, the second thin-film material, and the third thin-film material are deposited in every three rows spaces in that order.

10. The method as claimed in claim 5, wherein the ink is deposited in the spaces using an ink-jet device, and the ink-jet device comprises an ink-jet head and at least a nozzle on the ink-jet head.

11. The method as claimed in claim 10, wherein the ink-jet device is a thermal bubble ink-jet device or a piezoelectrical ink-jet device.

12. The method as claimed in claim 5, wherein the ink is solidified by at least one device selected from the group consisting of a heating device, a vacuum pump, and a light-exposure device.

13. The method as claimed in claim 12, wherein the light-exposure device is an ultraviolet light source.

14. The method as claimed in claim 10, wherein the irregular volume distribution of the ink is performed by controlling an irregularly-changed voltage applied on the at least nozzle.

15. The method as claimed in claim 14, wherein the irregular-changed voltage is a variable-magnitude voltage or a variable-waveform voltage.

16. The method as claimed in claim 15, wherein the variable-magnitude voltage is in a range from 80% to 120% of a standard voltage or an average voltage.

17. The method as claimed in claim 10, wherein the irregular volume distribution of the ink is performed by controlling a variable-number of the ink droplets deposited in the spaces.

18. The method as claimed in claim 17, wherein the variable-number of the ink droplets is in a range from 80% to 120% of a standard ink droplets or a average ink droplets.

19. A method for manufacturing a patterned thin-film layer, the method comprising the steps of:
providing a substrate with a plurality of banks thereon, the plurality of banks defining a plurality of spaces therein;
depositing ink into the spaces using a plurality of nozzles of at least one ink-jet device and having the relative movement in rows and columns between the plurality of nozzles and the substrate so that the ink of a same material deposited in the spaces in each row have an irregular volume distribution; and
solidifying the ink so as to form a plurality of patterned thin-film layers formed in the spaces in a manner such that the patterned thin-film layers made of the same material in each row have an irregular thickness distribution.

20. The method as claimed in claim 19, wherein the ink deposited in the spaces comprises a first thin-film material, a second thin-film material, and a third thin-film material, and the first thin-film material, the second thin-film material, and the third thin-film material are deposited in every three rows spaces in that order.

21. The method as claimed in claim 19, wherein the ink is solidified by at least one device selected from the group consisting of a heating device, a vacuum pump, and a light-exposure device.

22. The method as claimed in claim 21, wherein the light-exposure device is an ultraviolet light source.

23. The method as claimed in claim 19, wherein the irregular volume distribution of the ink is performed by controlling an irregularly-changed voltage applied on the at least nozzle.

24. The method as claimed in claim 23, wherein the irregular-changed voltage is a variable-magnitude voltage or a variable-waveform voltage.

25. The method as claimed in claim 24, wherein the variable-magnitude voltage is in a range from 80% to 120% of a standard voltage or an average voltage.

26. The method as claimed in claim 19, wherein the irregular volume distribution of the ink is performed by controlling a variable-number of the ink droplets deposited in the spaces.

27. The method as claimed in claim 26, wherein the variable-number of the ink droplets is in a range from 80% to 120% of standard ink droplets or average ink droplets.
